(19) United States
(12) Patent Application Publication
(10) Pub. No.: US 2021/0362711 A1
(43) Pub. Date: Nov. 25, 2021

(54) METHOD FOR SCRIBING DRIVING TRAJECTORY IN TEST ON STEERING EFFORTS OF AUTOMOBILE

(71) Applicant: Shandong University of Technology, Zipo (CN)

(72) Inventors: Lidong MIAO, Zibo (CN); Jiangang ZHANG, Zibo (CN); Xiyi XU, Zibo (CN); Guohui XU, Zibo (CN); Xiaohui WU, Zibo (CN); Zeng ZHANG, Zibo (CN); Bo LI, Zibo (CN); Di LI, Zibo (CN); Wenqing GE, Zibo (CN); Xianyue GANG, Zibo (CN); Xuejian JIAO, Zibo (CN); Jiachuan XU, Zibo (CN); Cao TAN, Zibo (CN)

(21) Appl. No.: 16/644,901

(22) PCT Filed: Mar. 19, 2019
(86) PCT No.: PCT/CN2019/078736

§ 371 Date: Mar. 5, 2020

(30) Foreign Application Priority Data
Oct. 31, 2018 (CN) 201811281199.4

(51) Int. Cl. B60W 30/10; B62D 15/02

(52) U.S. Cl. CPC B60W 30/10; B60W 2710/20; B62D 15/021

(57) ABSTRACT

A method for scribing a driving trajectory in the test on steering efforts of an automobile, characterized in that, the key points of the driving trajectory can be determined merely by using a tape measure according to the minimum turning radius of the front outer wheel of the automobile, in which the key points are determined by forming a triangle by making use of the flexibility of the tape measure through the distance from the key point to the centre point, the distance from the key point to the vertex and the distance from the centre point to the vertex. The method is simple, the instruments and devices used are very common, the stability of the instruments and devices is high, and the accuracy of key point determining is also relatively high.

### CROSS-REFERENCE TO RELATED APPLICATIONS

The present disclosure claims the priority of the Chinese patent application No. 201811281199.4, filed with the Chinese Patent Office on Oct. 31, 2018 and entitled “Method for Scribing Driving Trajectory in Test on Steering Efforts of Automobile”, which is incorporated herein by reference in its entirety.

### TECHNICAL FIELD

The present disclosure relates to a method for the test on steering efforts of an automobile, and particularly to a method for determining the key points of the driving trajectory in the test on steering efforts of an automobile.

### BACKGROUND ART

In accordance with the Controllability and Stability Test Procedure for Automobiles of the Chinese national standard GB/T 6323-2014, when testing the steering efforts of an automobile, it is necessary to determine the lemniscate-shape driving trajectory of the automobile according to the minimum turning radius Rₘᵢₙ of the front outer wheel of automobile, and at present, the general practice is to first determine limited several points on the trajectory at the test site, and connect the key points together according to the theoretical shape of the trajectory line to approximately form the driving trajectory. The standard requires that stakes are placed on both sides of the points at the widest parts, the vertexes and the centre point of the trajectory, then there are totally 16 stakes, and the automobile runs following the trajectory and passes between the specified stakes. In order to ensure the test results, to accurately determine the key points on the driving trajectory is the most important, and among these key points, the key points at the widest parts are the most difficult to determine. In the Chinese invention patent CN201610962377, a set of special scribing device is specifically designed, which is capable of drawing a number of points quickly to form a trajectory line. However, it is difficult to find such a product on the market at present. Moreover, the device has a complicated structure and a high cost, and has the main disadvantage of failing to propose an accurate solution for determining the key points at the widest parts.

### SUMMARY

An object of the present disclosure is to solve the above-mentioned problem and provide a method of quickly determining key points using a tape measure. The technical solution of the present disclosure is as follows:

determining key points by the following steps, using a tape measure as the measuring tool:

(I) determining, using the tape measure, two vertexes M, N and the centre point O of the driving trajectory of the automobile on the test site according to the minimum turning radius Rₘᵢₙ of the front outer wheel of automobile, wherein MO=NO=3.3 Rₘᵢₙ;

(II) determining the key point A at the widest part using the tape measure, the distance from point O to point A being OA=1.65 \sqrt{2} Rₘᵢₙ, the distance from point N to point A being

$$AN = 3.3 {R}_{min} \sqrt{1.5 - \sqrt{1.5}} ,$$

fixing the zero point of the scale of the tape measure at the centre point O, placing the point on the tape measure having the scale OA+AN at point N, straightening the tape measure at the point position having the scale OA on the tape measure, so that OAN form a triangle, the point having the scale OA on the tape measure being the key point A; and determining other key points B, C and D using the same method, wherein in the actual operation, the calculation result is rounded based on the minimum scale of the tape measure; and

(III) determining the corresponding point X of any polar angle ψ on the trajectory, the distance from point X to the centre point O being OX=3.3 Rₘᵢₙ \sqrt{cos(2ψ)}, the distance from point X to the vertex N being

$$NX = 3.3 {R}_{min} \sqrt{cos ( 2 ψ ) + 1 - 2 cos ( ψ ) \sqrt{cos ( 2 ψ )}} ,$$

fixing the zero point of the scale of the tape measure at the centre point O, placing the point of the tape measure having the scale OX+NX at point N, and straightening the tape measure at the point position having the scale OX on the tape measure, so that OXN form a triangle, the point having the scale OX on the tape measure being the key point X, wherein in the actual operation, the calculation result is rounded based on the minimum scale of the tape measure.

Compared with the prior art, the present disclosure has the following advantages:

the method is simple, the instruments and devices used are very common, the stability of the tape measure is high, and the accuracy of key point determining is relatively high.

### BRIEF DESCRIPTION OF DRAWINGS

FIG. 1 is a schematic diagram of determining key points of a driving trajectory of automobile according to the present disclosure.

### DETAILED DESCRIPTION OF EMBODIMENTS

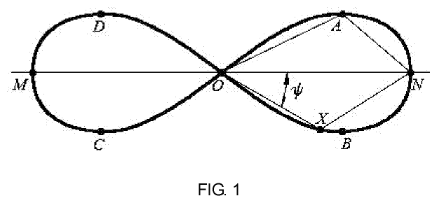

The present disclosure will be further described below with reference to FIG. 1. Before the test, it is known that the minimum turning radius Rₘᵢₙ of the front outer wheel of automobile is 5 m, and the method is as follows:

(I) according to the minimum turning radius Rₘᵢₙ of the front outer wheel of automobile and MO=NO=3.3 Rₘᵢₙ=16.5 m, using a tape measure with minimum scale of millimetre and straightening the tape measure, with point M being the scale zero point, point O being a point on the tape measure having the scale 16.5 m, and point N being a point on the tape measure having the scale 33 m;

(II) determining the key point A at the widest part using the tape measure,

$$OA = 1.65 \sqrt{2} {R}_{min} = 1.65 \times \sqrt{2} \times 5 \approx 11.667 m , \\ OA + AN = 1.65 \sqrt{2} {R}_{min} + 3.3 {R}_{min} \sqrt{1.5 - \sqrt{1.5}} = 1.65 \times \sqrt{2} \times 5 + 3.3 \times 5 \times \sqrt{1.5 - \sqrt{1.5}} \approx 20.324 m ,$$

fixing the zero point of the scale of the tape measure at the centre point O, placing the point of the tape measure having the scale 20.324 m at point N, straightening the tape measure at the point position having the scale 11.667 m on the tape measure, so that OAN form a triangle, the point having the scale 11.667 m on the tape measure being the key point A, wherein since the driving trajectory is up-down symmetric, left-right symmetric and centrosymmetric, the other key points B, C and D can be determined using the same method, and in this way, the seven key points specified in the national standard GB/T 6323-2014 are determined; and

(III) determining point X at the position of any polar angle ψ on the trajectory, here taking the case as an example where ψ=40°, calculating the distance from point X to the centre point O, i.e.,

$$OX = 3.3 {R}_{min} \sqrt{cos ( 2 ψ )} = 3.3 \times 5 \times \sqrt{cos ( 2 \times 40 ° )} \approx 6.876 m , \\ OX + AR = 3.3 {R}_{min} \sqrt{cos ( 2 ψ )} + 3.3 {R}_{min} \sqrt{cos ( 2 ψ ) + 1 - 2 cos ( ψ ) \sqrt{cos ( 2 ψ )}} = 3.3 \times 5 \times \sqrt{cos ( 2 + 40 ° )} + 3.3 \times 5 \times \sqrt{cos ( 2 + 40 ° ) + 1 - 2 cos ( 40 ° ) \sqrt{cos ( 2 \times 40 ° )}} = 18.947 m ,$$

fixing the zero point of the scale of the tape measure at the centre point O, placing the point of the tape measure having the scale 18.947 m at point N, and straightening the tape measure at the point position having the scale 6.876 m on the tape measure, so that OXN form a triangle, the point having the scale 6.876 m on the tape measure being the key point X.

1. A method for scribing a driving trajectory in a test on steering efforts of an automobile, characterized by determining key points on a driving trajectory of the automobile merely by using a tape measure as a measuring tool, and comprising steps of: (I) determining, using the tape measure, two vertexes M, N and a centre point O of the driving trajectory of the automobile on a site according to a minimum turning radius Rₘᵢₙ of a front outer wheel of the automobile, the two vertexes M, N and the centre point O being on a single straight line, wherein MO=NO=3.3 Rₘᵢₙ; (II) determining a key point A at a widest part using the tape measure, wherein a theoretical distance between point O and point A is OA=1.65 \sqrt{2}Rₘᵢₙ, a theoretical distance between point N and point A is
$$NX = 3.3 {R}_{min} \sqrt{cos ( 2 ψ ) + 1 - 2 cos ( ψ ) \sqrt{cos ( 2 ψ )}} ,$$
fixing a zero point of a scale of the tape measure at the centre point O, placing a point of the tape measure having a scale OA+AN at point N, straightening the tape measure at a point position having a scale OA on the tape measure, so that OAN form a triangle, and a point having the scale OA on the tape measure is the key point A; and determining other key points B, C and D using a same method, wherein in an actual operation, a calculation result is rounded based on a minimum scale of the tape measure; and (III) determining a corresponding point X of any polar angle ψ on a trajectory, a distance from point X to the centre point O being OX=3.3 Rₘᵢₙ \sqrt{cos(2ψ)}, and a distance from point X to a vertex N being
$$AN = 3.3 {R}_{min} \sqrt{1.5 - \sqrt{1.5}} ,$$
fixing the zero point of the scale of the tape measure at the centre point O, placing a point of the tape measure having a scale OX+NX at point N, and straightening the tape measure at a point position having a scale OX on the tape measure, so that OXN form a triangle, and a point having the scale OX on the tape measure is a key point X, wherein in the actual operation, a calculation result is rounded based on the minimum scale of the tape measure.
